(19) United States
(12) Patent Application Publication
(10) Pub. No.: US 2014/0096918 A1
(43) Pub. Date: Apr. 10, 2014

(54) System and method for preventing vertical blinds from tangling

(71) Applicant: John Vander Horst, Littleton, CO (US)

(72) Inventor: John Vander Horst, Littleton, CO (US)

(21) Appl. No.: 13/573,856

(22) Filed: Oct. 9, 2012

(51) Int. Cl. E06B 9/36; B23P 11/00

(52) U.S. Cl. CPC E06B 9/36; B23P 11/00
USPC 160/174 V; 29/428

(57) ABSTRACT

A system and method for preventing vertical blinds from tangling is disclosed. The system and method comprise the location of apertures at the vertical centers of rotation of the vertical vanes used in the blinds. A long thin member, such as a flexible cord, a flexible ribbon, or a rigid rod, is then placed through the apertures in a horizontal orientation and fixed on both ends. This prevents the vanes from overlapping one another in a manner that would cause entanglement.

### BACKGROUND

This disclosure relates to coverings for windows and doors and more specifically to vertical blinds used to shade the interior of a residence or commercial building.

Most vertical blinds hang freely from a head rail using clips at the top of each vane located at the center of vertical rotation of the vanes. The horizontal spacing and rotation of the clips about a vertical axis of rotation is controlled by a mechanism in the head rail that in turn is controlled by cords, rods, or motors responsive to sensors and/or operated by a user.

The vanes are generally free to swing about their points of attachment to the head rail in axes perpendicular to the vertical axis of rotation. In some cases there are untensioned cords connecting the vanes together near the bottoms of the vanes that limit the distance the vanes can swing, but many modern vertical blinds don't have these, meaning that the vanes have only a single point of attachment. Whether these untensioned cords are present or not, the vanes can easily swing individually in the wind or in response to users touching them. The vanes are often made of a flexible material, which allows them to bend and twist as well. As a result, external disturbances often causes the vanes to overlap in a configuration that does not allow the horizontal spacing between the clips holding the vanes be reduced when the blinds are opened. Careless users may then ignore the misaligned vanes and try to open the blinds by pulling too hard on the opening/closing cords or rod that control the spacing between the vanes to try to overcome the resistance created by overlapping vanes. These high forces to try clear jammed vanes can result in permanent damage to the system—or costly repairs. The frequency of damage and the high cost of repairs has caused vertical blinds not to be used in many situations where they would be optimal for shading a room while still allowing maximum visibility to the outdoors.

### SUMMARY

In one embodiment a system and method for preventing vertical blinds from tangling is disclosed. The system and method use an over-rotation prevention element that runs horizontally through openings in the vanes of a vertical blind system in a manner that prevents the vanes from having a total rotation about a vertical axis greater than approximately 180 degrees and/or prevents overlapping of the vanes in a way that impedes the opening of the blinds.

### BRIEF DESCRIPTION OF THE DRAWINGS

The present disclosure is described in conjunction with the appended figures in which:

FIG. 1 shows prior art vertical blinds mounted in front of a sliding glass door;

FIG. 2 shows the blinds of FIG. 1 with an over-rotation prevention element mounted through openings in each vane;

FIG. 3 shows the blinds of FIG. 1 or FIG. 2 with a valence mounted over the head rail and over-rotation prevention element;

FIGS. 4a to 4h show how the vanes of typical prior art vertical blinds get tangled and show how an embodiment of the present invention can mitigate this issue;

FIG. 5 shows a perspective view of an over-rotation prevention element mounted in a set of vanes;

FIG. 6a, FIGS. 6b, and 6c show configurations for openings in vanes suitable for use with an over-rotation prevention element; and

FIGS. 7a and 7b show examples of geometries for over-rotation prevention elements.

To assist in the understanding of one embodiment of the present invention, the following list of components or features and associated numbering found in the drawings is provided herein:

| Number | Component or Feature |
|---|---|
| 100 | Vertical blinds mounted in front of a sliding glass door |
| 101 | Vane |
| 101a | Vane rotated 90 degrees clockwise |
| 101b | Vane rotated 45 degrees counter-clockwise |
| 101w | Disrupted vane |
| 101x | Disrupted vane |
| 101y | Disrupted vane |
| 102 | Head rail |
| 103 | Vane rotation adjustment rod |
| 104 | Opener/closer cord |
| 105 | Valence |
| 106 | Vane attachment element (or clip) |
| 200 | Improved system |
| 201 | Over-rotation prevention element |
| 201a | Over-rotation prevention element having a flat profile |
| 202 | Attachment element |
| 203 | Opening |
| 203a | Keyhole notch opening |
| 203b | Shared opening |
| 204c | Elliptical opening |

It should be understood that the drawings are not necessarily to scale. In certain instances, details that are not necessary for an understanding of the invention or that render other details difficult to perceive may have been omitted. It should be understood that the invention is not necessarily limited to the particular embodiments illustrated herein.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It should be understood that various changes could be made in the function and arrangement of elements without departing from the spirit and scope as set forth in the appended claims.

Specific details are given in the following description to provide a thorough understanding of the embodiments. However, it will be understood by one of ordinary skill in the art that the embodiments may be practiced without these specific details. For example, shapes and geometries may be shown generically and details may be left out in order not to obscure the embodiments in unnecessary detail.

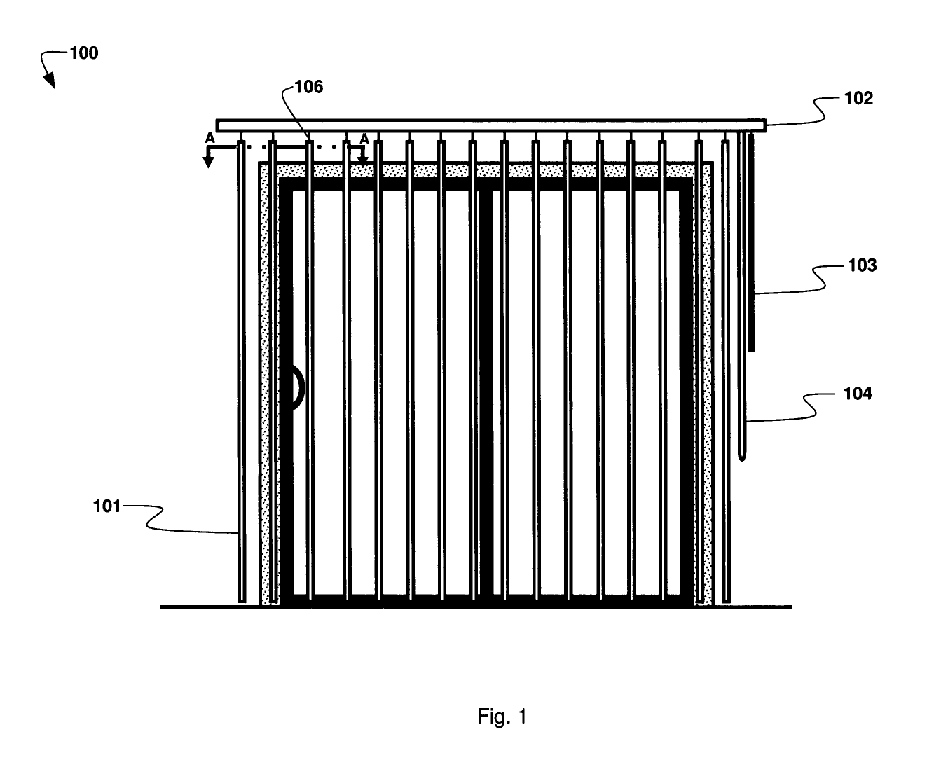

FIG. 1 shows typical prior art vertical blinds at 100. The blinds 100 have vertical vanes 101 connected to a horizontally mounted head rail 102, using vane attachment elements (clips) 106 that secure the vanes 101 to the head rail 102 at a point near the top of each vane 101. The vane attachment elements 106 allow the vanes 101 to hang freely, meaning that the vanes 101 are able to swing about axes perpendicular to their vertical axes of rotation (i.e. pivot about a horizontal plane) at a point near the tops of the vanes 101. The vanes 101 typically have a constant thickness and have a center of gravity located at their centers, which means that the vane attachment elements 106 are typically located at the centers of the tops of the vanes 101 in order for the vanes 101 to hang straight vertically. The vane attachment elements 106 typically connect securely to the vanes 101 by means of a hole in each vane 101 through which a part of the attachment element 106 is placed (i.e. clipped into).

Further referring to FIG. 1, the headrail 102 typically has a mechanism capable of moving the vane attachment elements 106 horizontally in a longitudinal direction in the headrail 102 using an opener/closer cord 104 hanging from one end of the head rail 102 to open or close the blinds wherein opening the blinds means moving the vane attachment elements 106 closer to one another to one or both ends of the head rail and closing the blinds means distributing the vane attachment elements longitudinally on the underside of the head rail. In some cases a motor instead of an opener/closer cord 104 moves the vanes. A second actuator, shown as a vane rotation adjustment rod 103, is used to rotate the vanes 101 in unison about their individual vertical axes of rotations to change the viewing angle through the vanes 101 or to move the vanes 101 to a position that blocks view completely. In some cases, a motor is used an actuator for rotating the vanes 101 instead of the vane rotation adjustment rod shown at 103.

By looking at FIG. 1, one can understand that the individually rotatable vanes are in a horizontally aligned row—meaning that centers of the tops of the vanes are all in a straight horizontal line. Since the vertical centers of rotation of the vanes intersect the centers of the tops of the vanes, the lines defining the vertical centers of rotation of the vanes are all in the same vertical plane. One can also see that each of the vanes of the system shown in FIG. 1 has a single attachment point, at its top. There are also vertical blinds that have multiple attachment points, one example of which is vertical blinds that have untensioned cords connecting the vanes together near the bottoms of the vanes that limit the distance the vanes can swing.

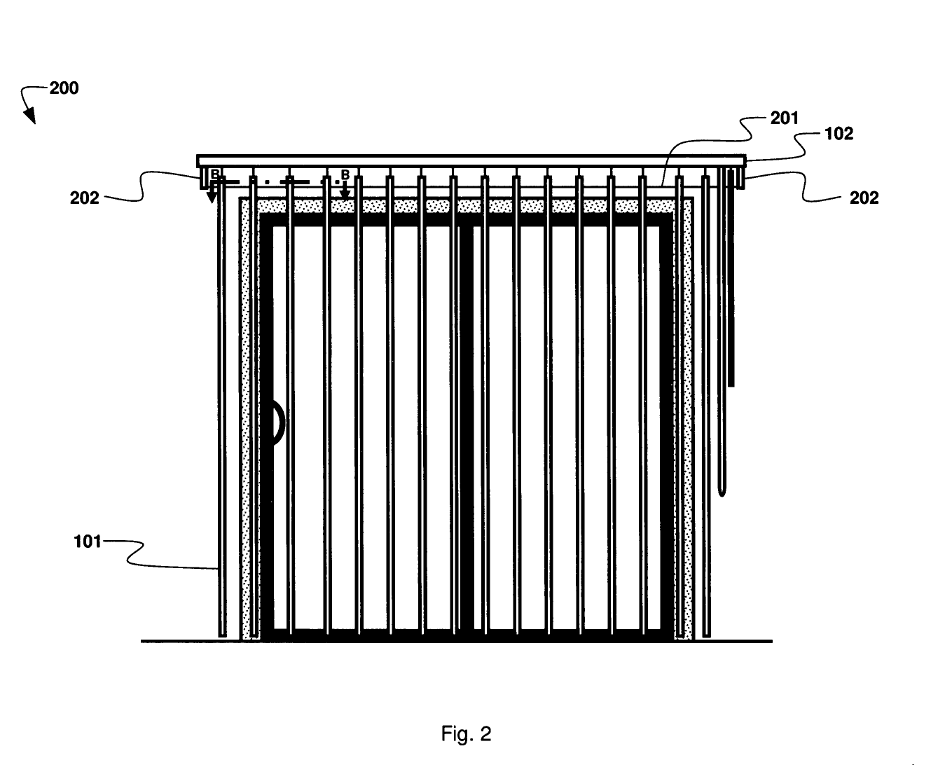

FIG. 2 shows an improved system 200 that incorporates an over-rotation prevention element, shown at 201, which goes through openings in the vanes 101 and prevents the vanes from rotating to a position that causes overlap. The over-rotation prevention element 201 is secured at both ends by attachment elements 202. The attachment elements 202 in the embodiment shown are located underneath and near the ends of the head rail. The attachment elements 202 may be secured to the head rail, the attachment elements 202 may be secured to a wall, or the attachment elements 202 may be secured to any other fixed points. The attachment elements 202 may be rigid or flexible. With the exceptions of the over-rotation prevention element 201, the attachment elements 202, and the openings in the vertical blinds (not shown), the improved system 200 is identical to the vertical blinds 100 shown in FIG. 1.

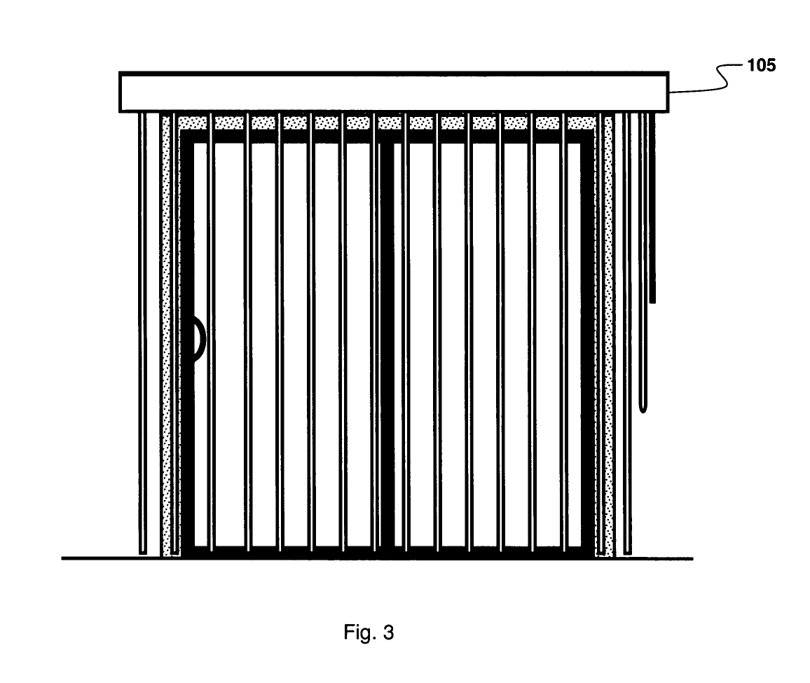

FIG. 3 shows the vertical blinds of FIG. 1 or FIG. 2 with a valence 105 that hides the vane attachment elements, 106 in FIG. 1, and head rail 102 in FIG. 1. The valence 105 can also hide the over-rotation prevention element 201 and attachment elements 202 shown in FIG. 2.

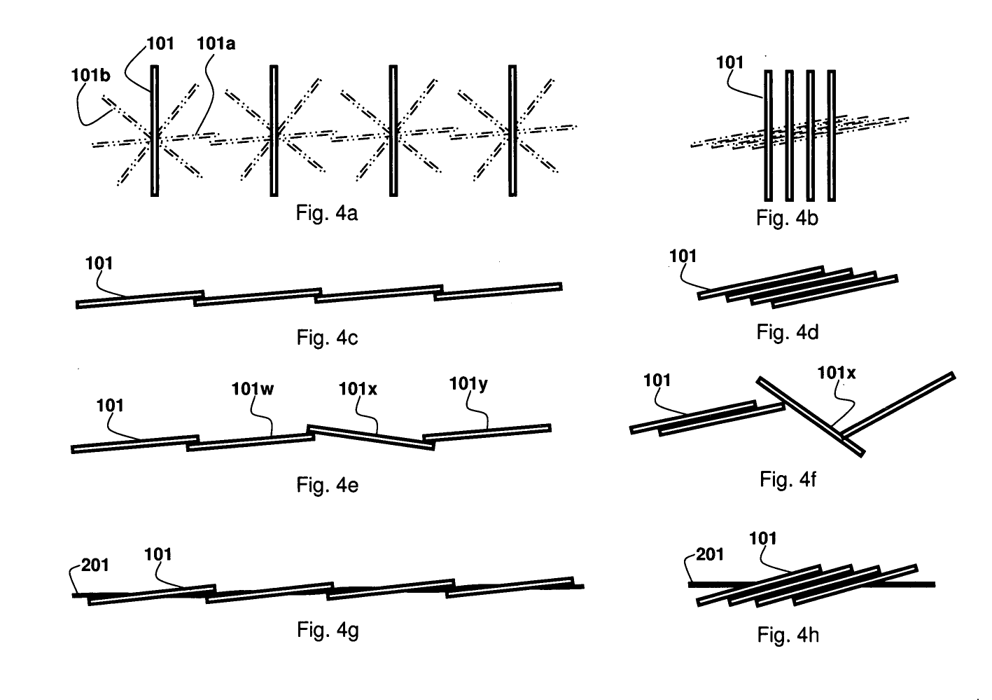

FIG. 4a to 4h illustrate the principle of operation of an embodiment of the present invention. FIG. 4a shows Section A-A of FIG. 1 in which the vanes 101 are spaced apart and rotated about a vertical axis to a straight visibility position that allows one to look straight through a window or sliding glass door. Phantom lines show what happens when the vanes 101 are rotated. Note that the rotation is about a vertical axis at a point close to the center of the vanes and that the allowed rotation of the vanes is approximately 90 degrees in each direction from the straight visibility position giving a total rotation of approximately 180 degrees from a point at which an end of a vane touches an adjacent vane to its right (as shown at 101a) to the point at which that same end of the vane touches an adjacent vane to its right (approximately 45 degrees of rotation beyond the position shown at 101b). FIG. 4b shows the same vanes 101 of FIG. 4a when the blinds are opened (i.e. centers of rotation moved together and to one side of the window or sliding glass door to be covered). FIGS. 4c and 4d show the vanes of FIG. 4a and FIG. 4b in positions that do not allow a user to see through a window or sliding glass door. In FIGS. 4a to 4d there is no tangling of the vanes and it is easy to open and close the blinds as one moves them from the position shown in FIG. 4a to the position shown in FIG. 4b or from the position shown in FIG. 4c to the position shown in FIG. 4d.

FIG. 4e shows vanes at 101w, 101x, and 101y that have been disrupted from their natural rotational limitations relative to one another, i.e. over-rotated. Over-rotation can be described as vanes that have been rotated past one another (overlapped) or have been rotated more than the natural 180 degrees of rotation for each vane 101 in a set of vertical blinds. Specifically over-rotation is illustrated in FIG. 4e by the following examples: (a) the same side of vane 101w is touching two adjacent vanes (101 and 101x) on opposite edges, (b) vane 101x is touching vane 101w on a side opposite of what a vane operating in its natural 180 degrees of rotation would touch a vane to its left (i.e. it has overlapped the vane to its left), (c) vane 101x is touching vane 101y on a side opposite of what a vane operating in its natural 180 degrees of rotation would touch a vane to its right (i.e. it has overlapped the vane to its right), and (d) the same side of vane 101y is touching an adjacent vane to its left on a side opposite of what would be natural. Disruptions of the types exhibited by vanes 101w, 101x, and 101y in FIG. 4g can be caused by wind or by a person sticking their hands through the blinds. FIG. 4f shows what occurs when one tries to slide the vanes 101 together when there is a disrupted vane 101x—the blinds cannot be opened. If one tries to use force, something bends or breaks, creating damage.

FIGS. 4g and 4h show section BB in FIG. 2 and illustrate an embodiment of the present invention—an over-rotation prevention element 201. The over-rotation prevention element 201 goes through an opening in each vane and prevents the vanes from rotating beyond a point where they will jam as was illustrated in FIG. 4f. Instead, the vanes 101 stay in proper orientation relative to one another, the vanes 101 cannot rotate more their natural 180 degrees of rotation, the vanes 101 cannot overlap, and the vertical blinds can be opened (i.e. centers of the vanes moved adjacent to each other) as illustrated in FIG. 4h.

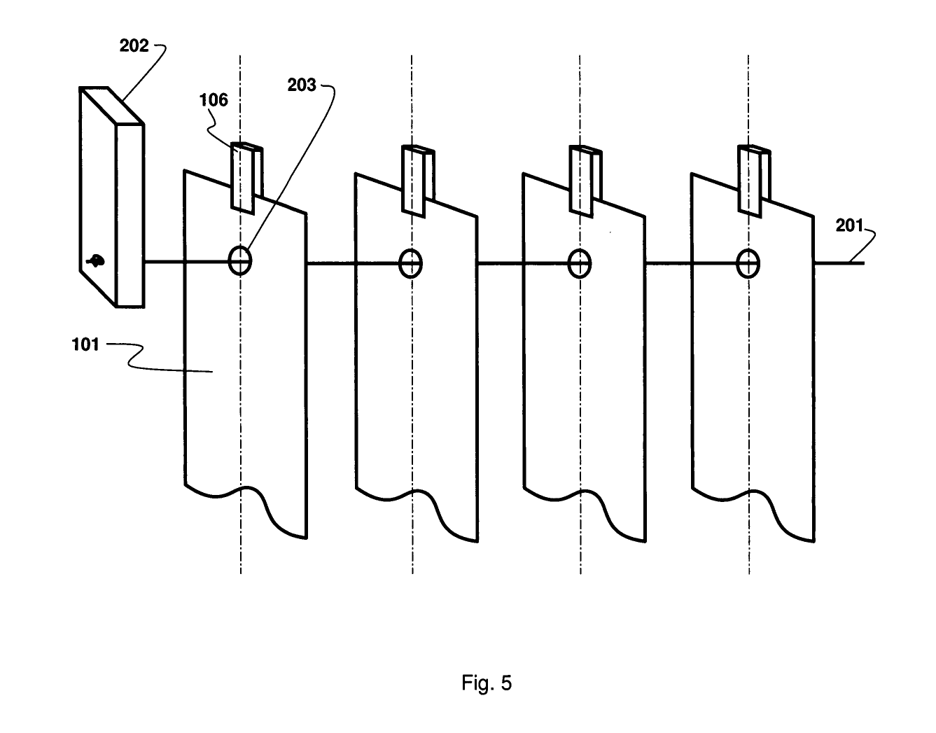

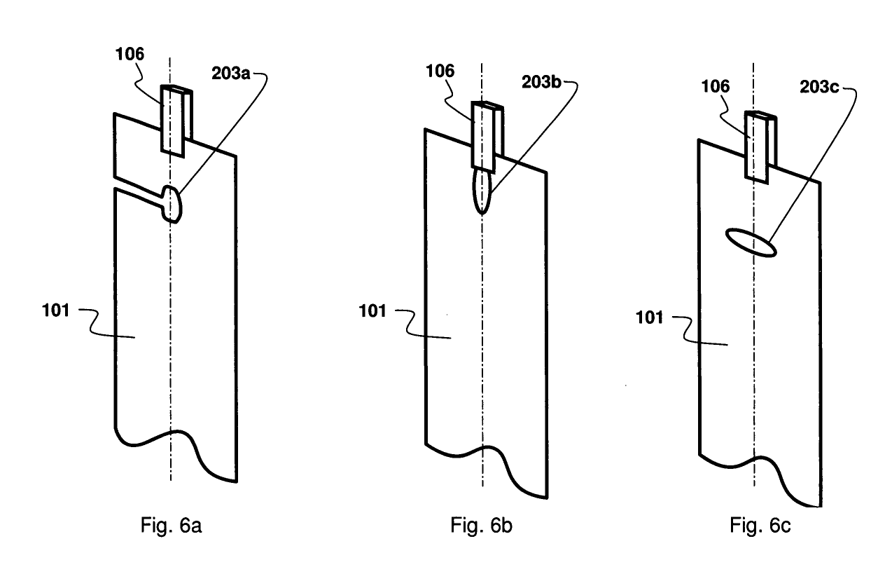

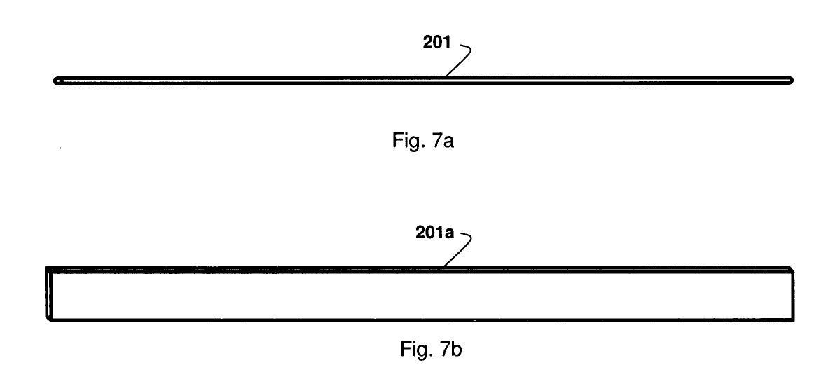

FIG. 5 provides an isometric view of the key elements of one embodiment of the present invention; FIG. 6a, FIG. 6b, and FIG. 6c show alternate embodiments of openings for an over-rotation prevention element 201; and FIG. 7a and FIG. 7b show alternate embodiments of the cross-sectional geometry of over-rotation prevention elements. FIG. 5 shows four vanes 101 hanging from clips 106. The over-rotation prevention element 201 is shown as a cord that is mounted to an attachment element 202. If the entire system were to be shown, there would be another attachment element 202 at the right side of the set of vanes 101. The over-rotation prevention element 201 goes through an opening 203 in each vane at approximately the vertical centers of rotation of the vertical vanes 101. In the embodiment shown, the openings 203 and over-rotation prevention element 201 are also located close to the clips 106 and near the tops of the vertical vanes 101. The openings in FIG. 5 are shown as round holes. FIG. 6a, FIG. 6b, and FIG. 6c show alternate embodiments of the openings such as a keyhole notch 203a, an opening that is part of the clip attachment hole 203b, and an elongated hole 203c. Referring to FIG. 6b, the opening 203b does not necessarily need to be below the vane attachment element 106, the opening 203b could also comprise an opening in the vane attachment element, thereby being integrated into the head rail attachment element. The over-rotation prevention element 201 in the embodiment shown in FIG. 5 is a tensioned round cord having a relatively small cross-sectional area. As shown by FIG. 6a, the over-rotation prevention element 201 can also be defined as having a cross-sectional width and height that is substantially less than its horizontal length in a direction parallel with the head rail (shown in FIG. 2). As shown by FIG. 7b, the over-rotation prevention element does not necessarily need to have a round cross sectional profile. The embodiment of the over-rotation prevention element 201a shown in FIG. 7b is a flat tape, strip, or ribbon that has a vertical dimension (i.e. height) that is much greater than its thickness. It is possible to fabricate an over-rotation prevention element 201 or 201a from a rigid material. It is also possible to fabricate an over-rotation prevention element 201 or 201a from a larger diameter flexible non-tensioned material. The specifics of the materials, cross-sectional size, cross-sectional shape, and rigidity of the over-rotation prevention element can be of any form or material capable of being understood by anyone skilled in the art.

Further referring to FIG. 5, the attachment element 202 shown connects to the over-rotation prevention element by means of a hole in the attachment element 202. This connection can be made in any form capable of being understood by anyone skilled in the art. There can be benefit to having an attachment means that provides and maintains tension if a flexible cord is to be used as the over-rotation prevention element. The attachment element 202 and over-rotation prevention element 201 can also be a single unit. The attachment element 202 can be secured to the head rail (102 in FIG. 2), to a wall, or to any other fixed location.

A number of variations and modifications of the disclosed embodiments can also be used. The principles described here can also be used for in applications other than vertical blinds. While the principles of the disclosure have been described above in connection with specific apparatuses and methods, it is to be clearly understood that this description is made only by way of example and not as limitation on the scope of the disclosure.

What is claimed is:

1. An over-rotation prevention system for a horizontally-aligned row of individually-rotatable vertical vane blinds hanging from a horizontal head rail, the over-rotation prevention system comprising:
an over-rotation prevention element comprising a long member wherein the long member is:
located below the head rail;
parallel to the head rail; and
positioned in a plane defined by a first vertical axis of rotation of a first vane and a second vertical axis of rotation of a second vertical vane;
a first opening in the first vane wherein the first opening is positioned to allow the member to pass through the first vane;
a second opening in the second vane wherein the second opening is positioned to allow the member to pass through the second vane;
a first attachment element that connects a first end of the long member to a first fixed position; and
a second attachment element that connects a second end of the long member to a second fixed position.

2. The system of claim 1 wherein the long member has a substantially circular cross section.

3. The system of claim 1 wherein the long member has a cross-sectional height greater than its thickness.

4. The system of claim 1 wherein the long member is in tension.

5. The system of claim 1 wherein the long member is flexible.

6. The system of claim 1 wherein the long member is rigid.

7. The system of claim 1 wherein the first opening and the second opening are circular.

8. The system of claim 1 wherein the first opening comprises a notch extending from the edge of the first vane and wherein the second opening comprises a notch extending from the edge of the second vane.

9. The system of claim 1 wherein the first opening is located near the top of the first vane and wherein the second opening is located near the top of the second vane.

10. The system of claim 1 wherein the first opening is integrated with a head rail attachment element for the first vane and wherein the second opening is integrated with a head rail attachment element for the second vane.

11. The system of claim 1 wherein the member prevents the first vane from rotating more than 180 degrees about its vertical axis and wherein the vertical member prevents the second vane from rotating more than 180 degrees about its vertical axis.

12. The system of claim 1 wherein the first fixed position further comprises a position on the head rail and wherein the second fixed position further comprises a position on the head rail.

13. The system of claim 1 suitable for use with vertical blinds having vanes with a single attachment point.

14. The system of claim 1 suitable for use with vertical blinds having vanes with a plurality of attachment points.

15. The system of claim 1 suitable for use with vertical blinds having flexible vanes.

16. The system of claim 1 suitable for use with vertical blinds having vanes that can pivot about a horizontal plane.

17. An over-rotation prevention system for blinds that have vertical vanes wherein the vanes hang from a substantially horizontal head rail in a configuration that allows the vanes to individually rotate about vertical rotational axes, the over-rotation prevention system comprising:
an opening in a plurality of the vanes wherein the opening in a vane comprises the vertical center of rotation of the vane;
an over-rotation prevention element comprising a long member wherein the long member passes through the openings in the vanes in a substantially horizontal direction substantially parallel with the head rail wherein the long member has two ends; and
a first attachment element that connects a first end of the long member to a first fixed position; and
a second attachment element that connects a second end of the long member to a second fixed position.

18. A method for preventing the tangling of substantially free hanging vertical vanes in a vertical blind system the method comprising the steps of:
establishing apertures in a plurality of the vanes wherein the apertures comprise spaces in the vertical centers of rotation of the vanes;
threading an elongated element through said spaces in a substantially horizontal direction whereby the elongated element prevents the vanes from rotating more than 180 degrees about said vertical axis; and
fixing the ends of the elongated element;
whereby the vertical edges of the vanes are prevented from overlapping in a manner that prevents the centers of rotation of the vanes from being moved close to each other.

19. The method of claim 5 wherein establishing further comprises apertures located near the top of the vertically hanging vanes.

20. The method of claim 5 wherein threading an elongated element further comprises threading a cord and wherein fixing the ends of said elongated member further comprises tension in said elongated member.
